(19) United States
(12) Patent Application Publication
(10) Pub. No.: US 2009/0039576 A1
(43) Pub. Date: Feb. 12, 2009

(54) AUXILIARY HANDLE DEVICE

(76) Inventors: Roswitha Eicher, Filderstadt (DE); Stefan Heess, Leinfelden-Echterdingen (DE); Joerg Maute, Sindelfingen (DE); Florian Esenwein, Uhingen-Holzhausen (DE); Bernhard Eicher, Filderstadt (DE); Marcus Schuller, Dettenhausen (DE)

Correspondence Address: Striker, Striker & Stenby, 103 East Neck Road, Huntington, NY, 11743, US

(21) Appl. No.: 12/132,346

(22) Filed: Jun. 3, 2008

(30) Foreign Application Priority Data
Aug. 6, 2007 (DE) 102007037081.6

(51) Int. Cl. B25F 5/02; B25D 17/04; B25G 1/00; B25G 1/01; B23B 45/00

(52) U.S. Cl. 267/137

(57) ABSTRACT

An auxiliary handle device, in particular for a hand-held power tool, has an auxiliary handle, a fastening unit provided for attachment with the hand-held power tool, and a damping unit with at least one absorber mass element. The absorber mass element is located at least partially on an end region of the auxiliary handle facing the fastening unit along an axial direction between the auxiliary handle and the fastening unit.

### CROSS-REFERENCE TO A RELATED APPLICATION

The invention described and claimed hereinbelow is also described in German Patent Application DE 102007037081.6 filed on Aug. 6, 2007. This German Patent Application, subject matter of which is incorporated herein by reference, provides the basis for a claim of priority of invention under 35 U.S.C. 119(a)-(d).

### BACKGROUND OF THE INVENTION

The present invention is directed to an auxiliary handle device.

An auxiliary handle device for a hand-held power tool is known, the auxiliary handle device including an auxiliary handle and a fastening unit provided for attachment with the hand-held power tool. The auxiliary handle device also includes a damping unit with an absorber mass element.

The present invention is directed to an auxiliary handle device, in particular for a hand-held power tool, with an auxiliary handle, a fastening unit provided for attachment with the hand-held power tool, and a damping unit with at least one absorber mass element.

It is provided that the absorber mass element is located at least partially on a end region of the auxiliary handle facing the fastening unit along an axial direction between the auxiliary handle and the fastening unit. In this context, an “auxiliary handle” is understood to be a region and/or a component and/or an element provided for placement—and enclosing, in particular—by one or two hands of an operator for guiding a hand-held power tool using an auxiliary handle device, and which is capable of being attached to the hand-held power tool in an auxiliary manner, adjacent to a further handle, in particular the main handle, the auxiliary handle device being located on the side of the hand-held power tool, and/or being capable of being removed from the hand-held power tool by an operator without the use of tools, and/or being located in a front region of the hand-held power tool close to the tool, and/or the auxiliary handle is designed in the shape of a rod.

An “absorber mass element” refers, in particular, to an element that is excited—at least within one intended frequency range of an initial oscillation and/or excitation oscillation—to generate a counter-oscillation that counteracts the initial or excitation oscillation, and therefore contributes to a reduction of vibrations. In addition, “between the auxiliary handle and the fastening unit” refers, in particular, to a spacial placement of the absorber mass element along a direction, preferably along an axial direction, inside the auxiliary handle device, with at least a subregion of the fastening unit projecting in one direction out of one side of the fastening unit facing away from the auxiliary handle and past the absorber mass element. “Provided” is intended to mean, in particular, specially equipped and/or designed. An “axial direction” is intended to mean, in particular, a direction along a longitudinal extension of the auxiliary handle device. The inventive design provides an advantageous damping of the auxiliary handle—of the gripping region in particular—and, therefore, a high level of operating comfort for an operator. The inventive auxiliary handle device is basically usable in conjunction with all hand-held power tools that appear reasonable to one skilled in the technical art, thereby making it easier, in particular, for an operator to guide hand-held power tools using the auxiliary handle. Due to its damping property, the auxiliary handle device is particularly advantageous when used with an angle grinder.

It is further proposed that the absorber mass element is designed in the shape of a disk, thereby making it possible to locate the absorber mass element inside the damping unit in a compact and particularly space-saving manner. “Disk-shaped” refers, in particular, to a design of the absorber mass element whose length, width, and/or diameter—of a main extension surface in particular—is several times greater than its thickness, which is oriented perpendicularly to the main extension surface.

Furthermore, the absorber mass element may be designed in the shape of a bolt, thereby making it possible to attain an advantageous, wear-reducing rolling motion using the absorber mast element during vibration damping between the fastening unit and the auxiliary handle. This may be attained in a particularly advantageous manner when the bolt-shaped absorber mass element includes at least one rounded end region. In this context, a “bolt-shaped” design refers, in particular, to a design of the absorber mass element with a length along a longitudinal extension that is several times greater than a thickness and/or depth of the absorber mass element oriented perpendicularly to the longitudinal extension.

A particularly captive placement of the absorber mass element may be attained when the bolt-shaped absorber mass element includes at least one end region that has a transverse extension that is larger than a transverse extension of a central subregion.

In an advantageous refinement of the present invention, it is provided that the damping unit includes at least one damping element that is designed to provide support in at least one direction of the absorber mass element. Support may therefore be attained using a simple design—while also damping vibrations using the damping element—in particular when the damping element is made of an elastomer and/or a ring and/or a coil spring and/or another type of damping element that appears reasonable to one skilled in the technical art and that is suitable for providing support.

It is also provided that the damping element is formed at least partially by a retaining element that is provided as a rotation lock to prevent the absorber mass element from rotating. In this context, a “rotation lock” refers, in particular, to a locking mechanism that prevents the absorber mass element from rotating, and/or from rotating around an axis, in particular the axis of an auxiliary handle, relative to the auxiliary handle, and/or the fastening unit. An undesired rotation and/or turning of the absorber mass element relative to the fastening unit and/or the auxiliary handle may be prevented and an advantageous starting position of the absorber mass element for a counter-oscillation may be attained or retained. This may also be attained in a particularly advantageous manner when the fastening unit and/or the absorber mass element and/or the auxiliary handle includes a retaining element that is provided to prevent the absorber mass element from rotating.

In a further advantageous embodiment of the present invention, it is provided that the auxiliary handle device includes at least one connecting element that captively connects the auxiliary handle with the fastening unit.

When the connecting element is designed flexurally soft in at least one direction, e.g., a chain and/or particularly advantageously a cable, in particular an elastically twisted steel cable, it is possible to advantageously absorb tension forces, such as the tension forces that occur in particular when the connecting element between the auxiliary handle and the fastening unit is preloaded. In this context, “flexurally soft” refers, in particular, to a property of an element that is basically unable to absorb forces in at least one direction, preferably a direction transverse to a longitudinal extension of the element, and the element is provided primarily to absorb tension forces in the direction of the longitudinal extension. A “cable” refers, in particular, to a longitudinal, flexurally soft, elastic element composed of individual, preferably wound fibers and/or wires, which is used to transfer tensile forces.

Furthermore, additional components, installation space, assembly effort and costs may be advantageously saved when the damping unit includes at least one damping element that is designed as a single piece with the connecting element.

Further advantages result from the description of the drawing, below. Exemplary embodiments of the present invention are shown in the drawing. The drawing, the description, and the claims contain numerous features in combination. One skilled in the art will also advantageously consider the features individually and combine them to form further reasonable combinations.

### BRIEF DESCRIPTION OF THE DRAWINGS

FIG. 1 shows a hand-held power tool with an inventive auxiliary handle device, in a schematic depiction

FIG. 2 shows the auxiliary handle device with a damping element that includes a disk-shaped absorber mass element, in a sectional view,

FIG. 3 shows the auxiliary handle device with an alternative damping element that includes a rod-shaped absorber mass element, in a sectional view, and

FIG. 4 shows the auxiliary handle device with a further, alternative damping element that includes a disk-shaped absorber mass element, in a sectional view.

### DESCRIPTION OF THE PREFERRED EMBODIMENTS

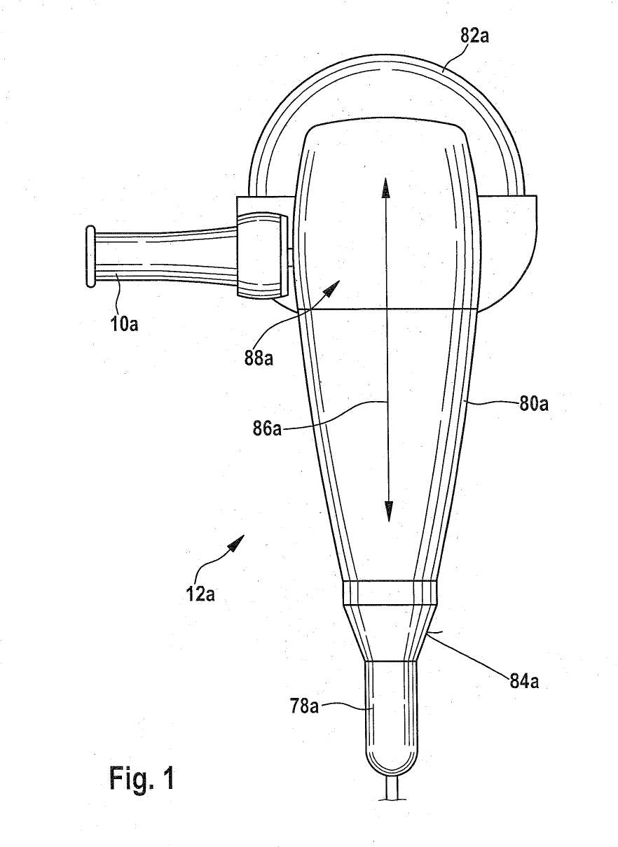

A hand-held power tool 12a designed as an angle grinder is shown in FIG. 1, in a perspective view from above. Angle grinder includes a housing 80a and a main handle 78a integrated in a housing 80a. Main handle 78a extends along a side 84a facing away from a tool 82a that is a cutting disk, in a longitudinal direction 86a of the angle grinder. An auxiliary handle device 10a is located in a front region 88a of the angle grinder that is close to the tool, and extends transversely to longitudinal direction 86a of the angle grinder.

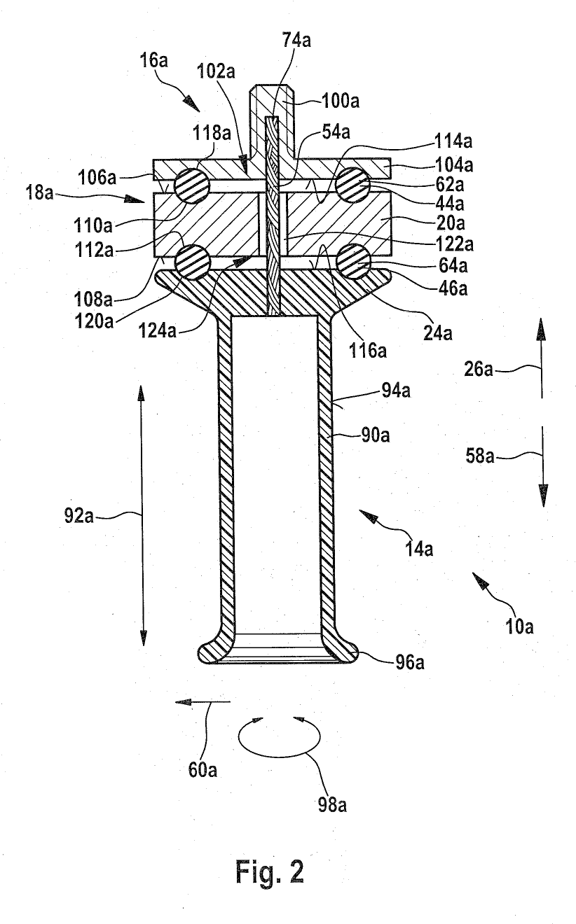

FIG. 2 shows auxiliary handle device 10a with an auxiliary handle 14a, a fastening unit 16a, and a damping unit 18a. Additional handle 14a includes a grip sleeve 90a, which extends along a main extension direction 92a of auxiliary handle device 10a. Auxiliary handle 14a and/or grip sleeve 90a has—on a surface 94a oriented radially outwardly along main extension direction 92a of auxiliary handle 14a—an outwardly curved shape, thereby providing a particularly good grip for an operator of auxiliary handle device 10a. A ridge-type raised area is provided along main extension direction 92a in end regions 24a, 96a of grip sleeve 90a, which limits a gripping region of grip sleeve 90a for an operator of auxiliary handle device 10a along main extension direction 92a. The two ridge-type raised areas are located on auxiliary handle 14a in the manner of rings, in a circumferential direction 98a, which extends perpendicularly to main extension direction 92a, and they extend radially outwardly from auxiliary handle 14a. During operation of auxiliary handle device 10a, ridge-type raised areas prevent the operator's hand from slipping when the operator guides hand-held power tool 12a using auxiliary handle device 10a and/or while force is being transmitted by the operator via auxiliary handle device 10a to hand-held power tool 12a.

Damping unit 18a includes a disk-shaped absorber mass element 20a located along an axial direction 26a, 58a oriented parallel to main extension direction 92a, between end region 24a facing fastening unit 16a and fastening unit 16a itself. Disk-shaped absorber mass element 20a is provided to absorb vibrational and oscillatory energy, which may be transferred via fastening unit 16a to auxiliary handle 14a during operation of hand-held power tool 12a. To this end, disk-shaped absorber mass element 20a is excited via the vibrational and oscillatory energy of hand-held power tool 12a to generate a counter-oscillation, which counteracts an initial oscillation or vibration of hand-held power tool 12a. Fastening unit 16a includes a bolt-shaped fastening element 100a, which may be screwed together with hand-held power tool 12a. Fastening unit 16a also includes a disk-shaped basic element 104a in a region 102a facing auxiliary handle 14a, disk-shaped basic element 104a being designed as a single piece with bolt-shaped fastening element 100a.

Along axial direction 26a, 58a, a damping element 44a, 46a or damping unit 18a is located between end region 24a facing fastening unit 16a and absorber mass element 20a, and between absorber mass element 20a and disk-shaped basic element 104a. Damping elements 44a, 46a are formed by elastomer rings, and are designed to provide additional damping of oscillations and/or to prevent a direct transmission of vibrations from fastening unit 16a via absorber mass element 20a to auxiliary handle 14a. To accommodate damping elements 44a, 46a, absorber mass element 20a includes—on a side 106a facing fastening unit 16a and on a side 108a facing auxiliary handle 14a—a circular groove 110a, 112a, in which one of the damping elements 44a, 46a is installed. To support and/or accommodate annular damping elements 44a, 46a, a circular groove 118a, 120a is provided in disk-shaped basic element 104a of fastening unit 16a on a side 114a facing absorber mass element 20a, and in end region 24a, on a side 116a facing fastening unit 16a.

Damping elements 44a, 46a are also designed as retaining elements 62a, 64a, and they are integrally extruded on end region 24a of auxiliary handle 14a, on absorber mass element 20a, and disk-shaped basic element 104 of fastening unit 16a, so that absorber mass element 20a is protected against turning or rotating in circumferential direction 98a relative to fastening unit 16a and/or auxiliary handle 14a. It is also feasible, in principle, that circular grooves 110a, 112a, 118a, 120a of absorber mass element 20a, disk-shaped basic element 104a and/or end region 24a include segment-type retaining elements that extend in a radial direction 60a inside grooves 110a, 112a, 118a, 120a and engage in corresponding recesses in annular damping elements 44a, 46a, thereby resulting in a rotation lock. It is also feasible that damping elements 44a, 46a are formed as elastomer balls that are supported in ball cages of absorber mass element 20a, of end region 24a and/or of disk-shaped basic element 104a, thereby resulting in a rotation lock of absorber mass element 20a.

Auxiliary handle device 10a also includes a connecting element 74a, which is provided for captively connecting fastening unit 16a with auxiliary handle 14a. Connecting element 74a is also formed by a damping element 54a of damping unit 18a, thereby resulting in a captive placement of fastening unit 16a and simultaneously providing an additional damping of oscillations between fastening unit 16a and auxiliary handle 14a during operation of auxiliary handle device 10a, and preventing a direct transfer of vibrations via connnecting element 74a between fastening unit 16a and auxiliary handle 14a. Connecting element 74a is formed as a flexurally soft, woven steel cable, and it is pressed together with end region 24a of additional handle 14a and with fastening unit 16a facing fastening unit 16a. It is also feasible, in principle, that connecting element 74a is screwed together with fastening unit 16a and/or end region 24a facing fastening unit 16a. For placement of connecting element 74a, disk-shaped absorber mass element 20a includes a cylindrical hole 122a that extends in axial direction 26a, 58a, through which connecting element 74a is guided. Hole 122a is located in a central subregion 124a of disk-shaped absorber mass element 20a.

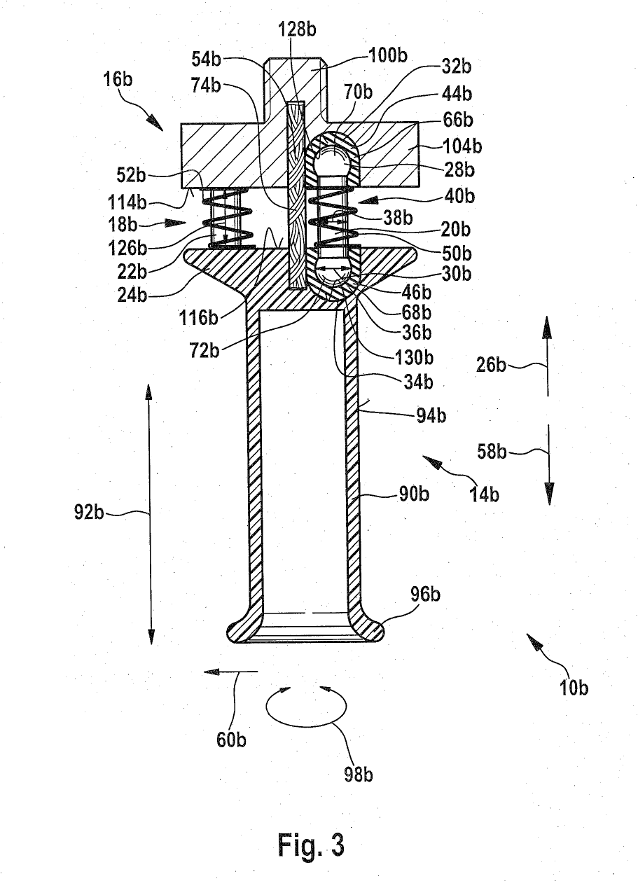

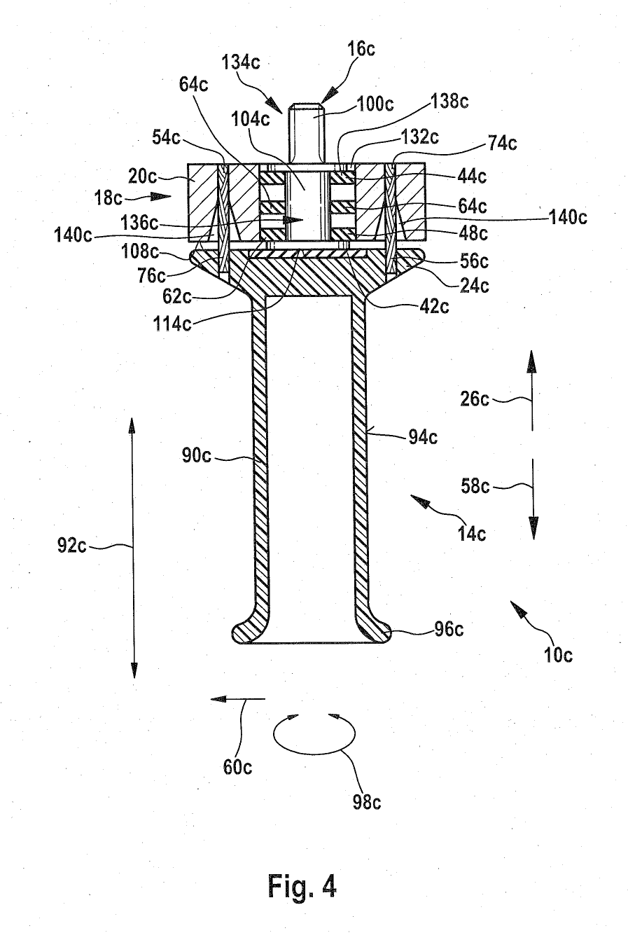

Alternative exemplary embodiments are shown in FIGS. 3 and 4. Components, features, and functions that are essentially the same are labelled with the same reference numerals. To distinguish the exemplary embodiments from each other, the reference numerals of the exemplary embodiments are appended with the letters a through c. The description below is essentially limited to the differences from the exemplary embodiment in FIGS. 1 and 2. With regard for the components, features, and functions that remain the same, reference is made to the description of the exemplary embodiment in FIGS. 1 and 2.

FIG. 3 shows an alternative auxiliary handle device 10b with a damping unit 18b, an auxiliary handle 14b, and a fastening unit 16b. Damping unit 18b includes several—but at least three—absorber mass elements 20b, 22b, which are designed in the shape of bolts and have a main extension direction 126b in an axial direction 26b, 58b. Bolt-shaped absorber mass elements 20b, 22b are evenly spaced and separated from each other in a circumferential direction 98b, thereby making it possible to provide the most even vibration damping possible for an operator of auxiliary handle device 10b.

To accommodate bolt-shaped absorber mass elements 20b, 22b, a disk-shaped basic element 104b of fastening unit 16b and an end region 24b of auxiliary handle 14b facing fastening unit 16b include cylindrical, capsule-type recesses 128b, 130b. Capsule-type recesses 128b, 130b are also formed by retaining elements 66b, 68b, which prevent absorber mass elements 20b, 22b from rotating in circumferential direction 98b relative to fastening unit 16b and/or auxiliary handle 14b. It is also feasible to provide disk-shaped basic element 104b and/or end region 24b with a groove for accommodating bolt-shaped absorber mass elements 20b, 22b. Capsule-type recesses 128b, 130b of disk-shaped basic element 104b and of end region 24b facing fastening unit 16b include rounded end regions 32b, 34b.

Bolt-shaped absorber mass elements 20b, 22b also include rounded end regions 28b, 30b, which make is possible for bolt-shaped absorber mass elements 20b, 22b to advantageously roll in capsule-type recesses 128b, 130b when a vibration-damping counter-oscillation motion is carried out during operation. In addition, end regions 28b, 32b of bolt-shaped absorber mass elements 20b, 22b are designed as retaining elements 70b, 72b, and they are provided with a transverse extension 36b that is larger than a transverse extension 38b of a central subregion 40b. Capsule-type damping elements 44b, 46b made of an elastomer are located inside capsule-type recesses 128b, 130b in disk-shaped basic element 104b and end region 24b. Capsule-type damping elements 44b, 46b are integrally extruded on disk-shaped basic element 104b, bolt-shaped absorber mass element 20b, 22b, and end region 24b. To further support a damping effect of damping unit 18b, it includes further damping units 50b, 52b, 54b, which are formed by a steel cable and coil springs. The steel cable is designed as a connecting element 74b between end region 24b facing fastening unit 16b and fastening unit 16b. The coil springs are located around one of the bolt-shaped absorber mass elements 20b, 22b and are oriented in axial direction 26b, 58b.

FIG. 4 shows an alternative auxiliary handle device 10c with a damping unit 18c. Damping unit 18c includes a disk-shaped absorber mass element 20c. Disk-shaped absorber mass element 20c includes a recess 132c, which extends in axial direction 26c, 58c, is located in the center, and is formed by a hole. Recess 132c is provided to accommodate a basic element 104c of a fastening unit 16c that has an I-shaped profile in axial direction 26c, 58c. In a region 134c facing away from auxiliary handle 14c, fastening unit 16c includes a fastening element 100c that abuts I-shaped basic element 104c in axial direction 26c, 58c and extends beyond disk-shaped absorber mass element 20c. On a side 114c facing auxiliary handle 14c, fastening unit 16c and basic element 104c are supported on auxiliary handle 14c via a disk-shaped damping element 42c made of an elastomer. Three annular damping elements 44c, 46c, 48c made of an elastomer are integrally extruded on a central subregion 136c of basic element 104c in axial direction 26c, 58c.

Damping elements 44c, 46c, 48c are also integrally extruded on disk-shaped absorber mass element 20c, on a side facing away from basic element 104c. Damping elements 44c, 46c, 48c are also designed as retaining elements 138c, 62c, 64c, which prevent absorber mass element 20c from turning or rotating in circumferential direction 98c relative to auxiliary handle 14c and/or fastening unit 16c. Fastening unit 16c is connected with auxiliary handle 14c via disk-shaped absorber mass element 20c. To this end, auxiliary handle device 10c includes several—but at least three—connecting elements 74c, 76c, each of which is formed by a damping element 54c, 56c. Connecting elements 74c, 76c are also formed by a flexurally soft, elastically twisted steel cable, thereby ensuring the most stable support possible of absorber mass element 20c and fastening unit 16c. The steel cables are pressed together with absorber mass element 20c and end region 24c facing fastening unit 16c. In order to realize the counter-vibration of disk-shaped absorber mass element 20c required to dampen oscillations during operation of auxiliary handle device 10c, absorber mass element 20c includes a recess 140c on a side 108c facing auxiliary handle 14c, which extends—tapered conically—into disk-shaped absorber mass element 20c.

It will be understood that each of the elements described above, or two or more together, may also find a useful application in other types of constructions differing from the type described above.

While the invention has been illustrated and described as embodied in an auxiliary handle device, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An auxiliary handle device, comprising an auxiliary handle; a fastening unit configured for attachment with a hand-held power tool; a damping unit with at least one absorber mass element, said absorber mass element being located at least partially on an end region of said auxiliary handle facing said fastening unit along an axial direction between said auxiliary handle and said fastening unit.

2. An auxiliary handle device as defined in 1, wherein said absorber mass element is configured as a disk-shaped absorber mass element.

3. An auxiliary handle device as defined in 1, wherein said absorber mass element is configured as a bolt-shaped absorber mass element.

4. An auxiliary handle device as defined in 3, wherein said bolt-shaped absorber mass element includes at least one rounded end region.

5. An auxiliary handle device as defined in 3, wherein said bolt-shaped absorber mass element includes at least one end region that has a transverse extension which is larger than a transverse direction of a central subregion.

6. An auxiliary handle device as defined in 1, wherein said damping unit includes at least one damping element that is provided as a support in at least one direction of said absorber mass element.

7. An auxiliary handle device as defined in 6, wherein said damping element is composed of an elastomer.

8. An auxiliary handle device as defined in 6, wherein said damping element is configured as a ring-shaped damping element.

9. An auxiliary handle device as defined in 6, wherein said damping element is configured as a coil spring.

10. An auxiliary handle device as defined in 6, wherein said damping element is formed at least partially by a retaining element which is configured to prevent said absorber mass element from rotating.

11. An auxiliary handle device as defined in 1, wherein an element selected from the group consisting of said fastening unit, said absorber mass element, said auxiliary handle, and combinations thereof includes a retaining element which is provided to prevent said absorber mass element from rotating.

12. An auxiliary handle device as defined in claim 1; and further comprising at least one connecting element which captively connects said auxiliary handle with said fastening unit.

13. An auxiliary handle device as defined in claim 12, wherein said connecting element is configured to be flexurally soft in at least one direction.

14. An auxiliary handle device as defined in 12, wherein said connecting element is configured as a cable.

15. An auxiliary handle device as defined in 12, wherein said damping unit includes at least one damping element which is configured as a single piece with said connecting element.

16. A hand-held power tool, comprising a main handle; and an auxiliary handle device including an auxiliary handle, a fastening unit configured for attachment with the hand-held power tool, a damping unit with at least one absorber mass element, said absorber mass element being located at least partially on an end region of said auxiliary handle facing said fastening unit along an axial direction between said auxiliary handle and said fastening unit.

17. A hand-held power tool as defined in claim 16, wherein the hand-held power tool is configured as an angle grinder.
